(19) United States
(12) Patent Application Publication
(10) Pub. No.: US 2015/0197002 A1
(43) Pub. Date: Jul. 16, 2015

(54) BIT RETENTION ASSEMBLY FOR ROTARY HAMMER

(71) Applicant: Milwaukee Electric Tool Corporation, Brookfield, WI (US)

(72) Inventors: Will Didier, Cedarburg, WI (US); Benjamin J. Ludy, Milwaukee, WI (US)

(21) Appl. No.: 14/155,767

(22) Filed: Jan. 15, 2014

(51) Int. Cl. B25D 17/08; B25D 16/00

(52) U.S. Cl. CPC B25D 17/088; B25D 16/00

(57) ABSTRACT

A bit retention assembly, for securing a tool bit to a spindle of a rotary hammer, includes a plurality of detent members movable in unison from a locking position to an insertion position in response to insertion of the tool bit within the spindle, a biasing member configured to bias the detent members toward the locking position, and a collar movable along the spindle between a first axial position and a second axial position. The collar has an annular wall at least partially defining a pocket. A first end of the biasing member is received within the pocket when the detent members are in the locking position such that the first end of the biasing member is radially constrained by the annular wall.

### FIELD OF THE INVENTION

The present invention relates to rotary power tools, and more particularly to bit retention assemblies for rotary power tools.

### BACKGROUND OF THE INVENTION

Rotary hammers typically include a rotatable spindle, a reciprocating piston within the spindle, and a striker that is selectively reciprocable within the piston in response to an air pocket developed between the piston and the striker. Rotary hammers also typically include an anvil that is impacted by the striker when the striker reciprocates within the piston. The impact between the striker and the anvil is transferred to a tool bit, causing it to reciprocate for performing work on a work piece. Rotary hammers further include bit retention assemblies for securing a tool bit within the spindle.

### SUMMARY OF THE INVENTION

The invention provides, in one aspect, a rotary hammer adapted to impart axial impacts to a tool bit. The rotary hammer includes a motor, a spindle coupled to the motor for receiving torque from the motor, a piston at least partially received within the spindle for reciprocation therein, and an anvil received within the spindle for reciprocation in response to reciprocation of the piston. The anvil imparts axial impacts to the tool bit in response to reciprocation of the piston. The rotary hammer also includes a bit retention assembly for securing the tool bit to the spindle. The bit retention assembly includes a plurality of detent members movable in unison from a locking position to an insertion position in response to insertion of the tool bit within the spindle, a biasing member configured to bias the detent members toward the locking position, and a collar movable along the spindle between a first axial position and a second axial position. The collar has an annular wall at least partially defining a pocket. A first end of the biasing member is received within the pocket when the detent members are in the locking position such that the first end of the biasing member is radially constrained by the annular wall.

The invention provides, in another aspect, a bit retention assembly for securing a tool bit to a spindle of a rotary hammer. The bit retention assembly includes a plurality of detent members movable in unison from a locking position to an insertion position in response to insertion of the tool bit within the spindle, a biasing member configured to bias the detent members toward the locking position, and a collar movable along the spindle between a first axial position and a second axial position. The collar has an annular wall at least partially defining a pocket. A first end of the biasing member is received within the pocket when the detent members are in the locking position such that the first end of the biasing member is radially constrained by the annular wall.

Other features and aspects of the invention will become apparent by consideration of the following detailed description and accompanying drawings.

### BRIEF DESCRIPTION OF THE DRAWINGS

FIG. 1 is a perspective view of a rotary hammer embodying aspects of the invention.

FIG. 2 is a cross-sectional view of the rotary hammer along line 2-2 in FIG. 1.

FIG. 3 is an exploded view of a bit retention assembly for use with the rotary hammer of FIG. 1.

FIG. 4 is a cross-sectional view of the rotary hammer along line 4-4 in FIG. 1.

FIG. 5 is a cross-sectional view of the bit retention assembly of FIG. 2, illustrating a tool bit being inserted within a spindle of the rotary hammer.

FIG. 6 is a cross-sectional view of the bit retention assembly of FIG. 2, illustrating the tool bit fully inserted within the spindle.

FIG. 7 is a cross-sectional view of the bit retention assembly of FIG. 2, illustrating a collar of the bit retention assembly being moved to a rearward position to permit removal of the tool bit from the spindle

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

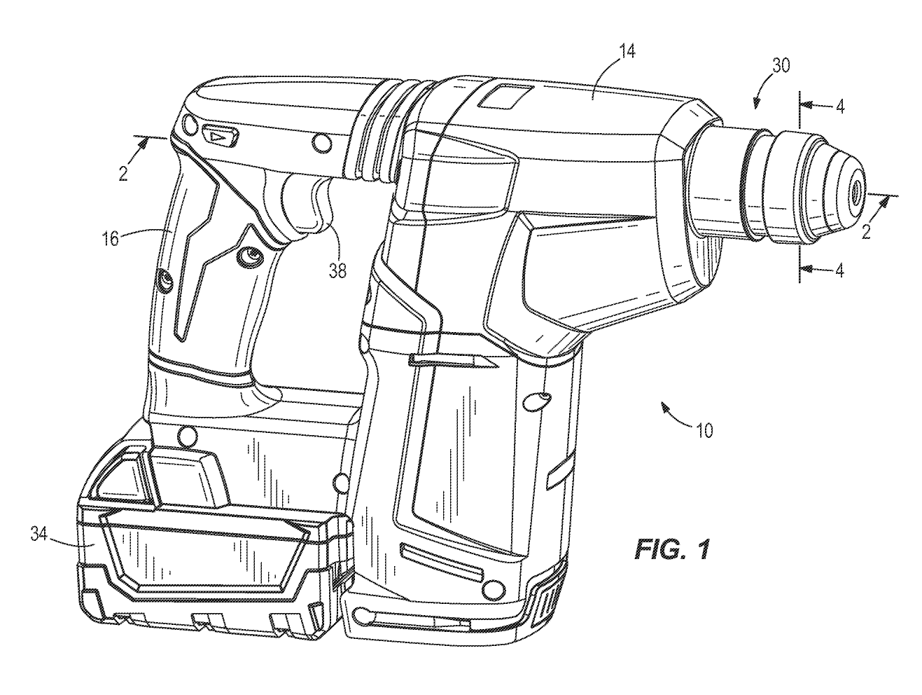

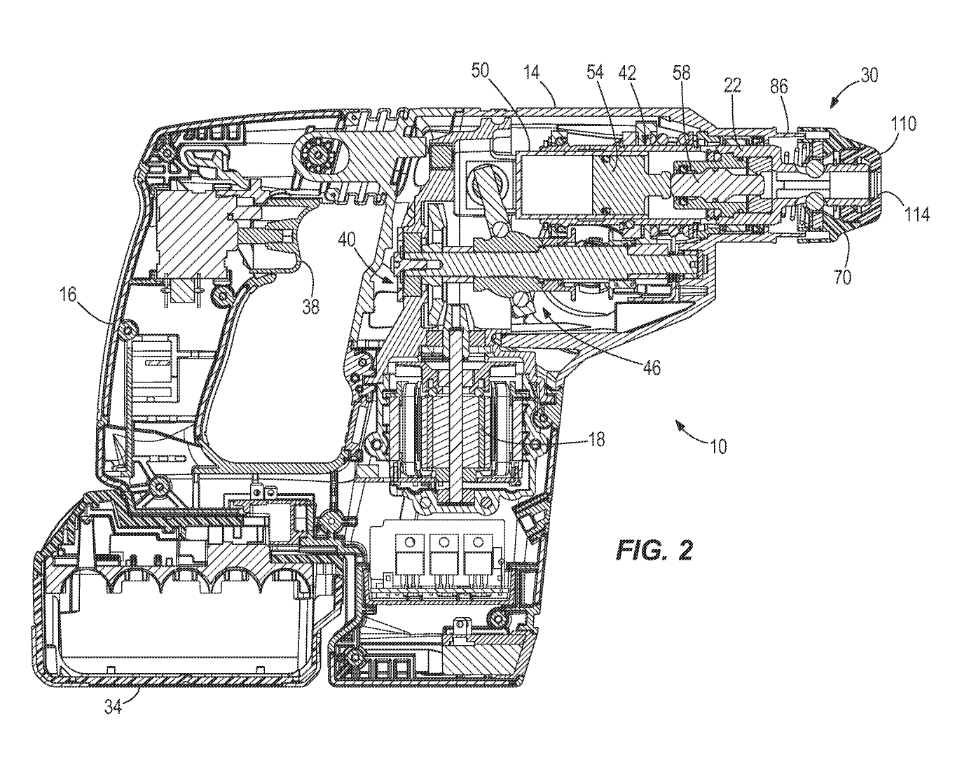

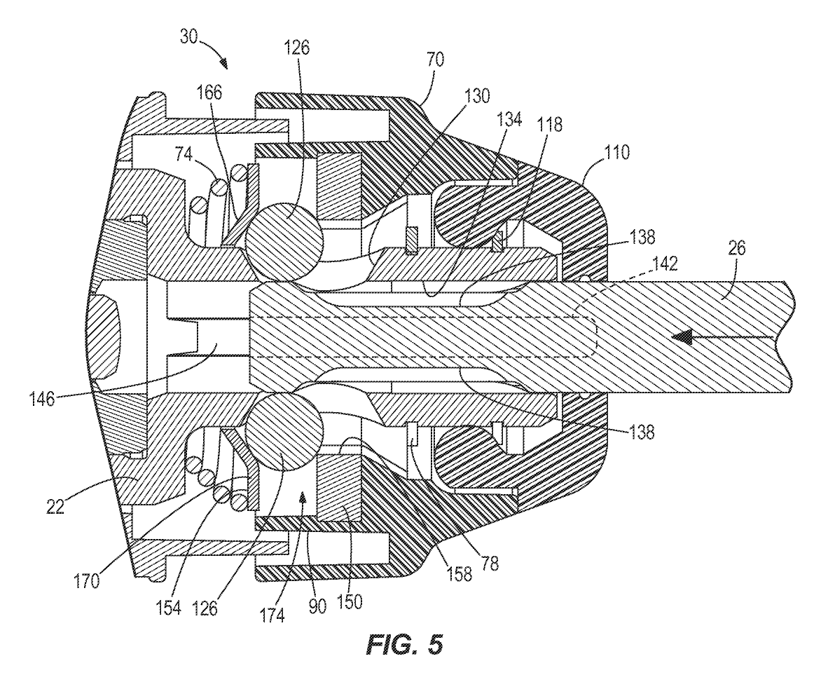

FIG. 1 illustrates a rotary hammer 10 including a housing 14 and a handle 16 coupled to the housing 14. With reference to FIG. 2, the rotary hammer 10 further includes a motor 18 disposed within the housing 14 and a rotatable spindle 22 coupled to the motor 18 for receiving torque from the motor 18. A tool bit 26 (FIGS. 5-7) may be secured to the spindle 22 for co-rotation with the spindle 22 (e.g., using a spline-fit). As described in more detail below, the rotary hammer 10 also includes a bit retention assembly 30 coupled for co-rotation with the spindle 22 to facilitate quick removal and replacement of different tool bits 26.

In the illustrated construction of the rotary hammer 10, the motor 18 is configured as a DC motor 18 that receives power from an on-board power source 34 (e.g., a battery, FIG. 1). The battery 34 may include any of a number of different nominal voltages (e.g., 12V, 18V, etc.), and may be configured having any of a number of different chemistries (e.g., lithium-ion, nickel-cadmium, etc.). Alternatively, the motor 18 may be powered by a remote power source (e.g., a household electrical outlet) through a power cord. The motor 18 is selectively activated by depressing a trigger 38 which, in turn, actuates a switch. The switch may be electrically connected to the motor 18 via a top-level or master controller, or one or more circuits, for controlling operation of the motor 18.

With reference to FIG. 2, the rotary hammer 10 also includes a transmission 40 for transferring torque from the motor 18 to the spindle 22, an impact mechanism 42 driven by the transmission 40 for delivering repeated impacts to the tool bit 26, and a reciprocation mechanism 46 for converting torque received from the motor 18 to a reciprocating force acting on the impact mechanism 42. In the illustrated embodiment, the impact mechanism 42 includes a reciprocating piston 50 disposed within the spindle 22 movable between a forward-most position within the spindle 22 and a rearward-most position within the spindle 22. The impact mechanism 42 also includes a striker 54 that is selectively reciprocable within the spindle 22 in response to reciprocation of the piston 50, and an anvil 58 that is impacted by the striker 54 when the striker 54 reciprocates toward the tool bit 26. The impact between the striker 54 and the anvil 58 is transferred to the tool bit 26, causing it to reciprocate for performing work on a work piece. In the illustrated construction of the rotary hammer 10, an air pocket is developed between the piston 50 and the striker 54 when the piston 50 reciprocates within the spindle 22, whereby expansion and contraction of the air pocket induces reciprocation of the striker 54.

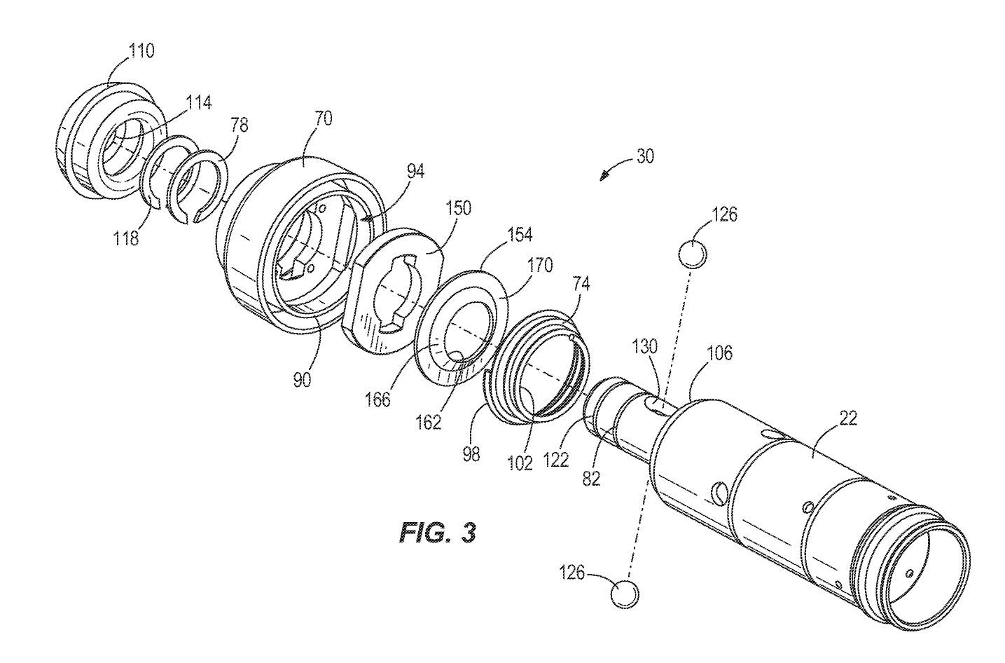

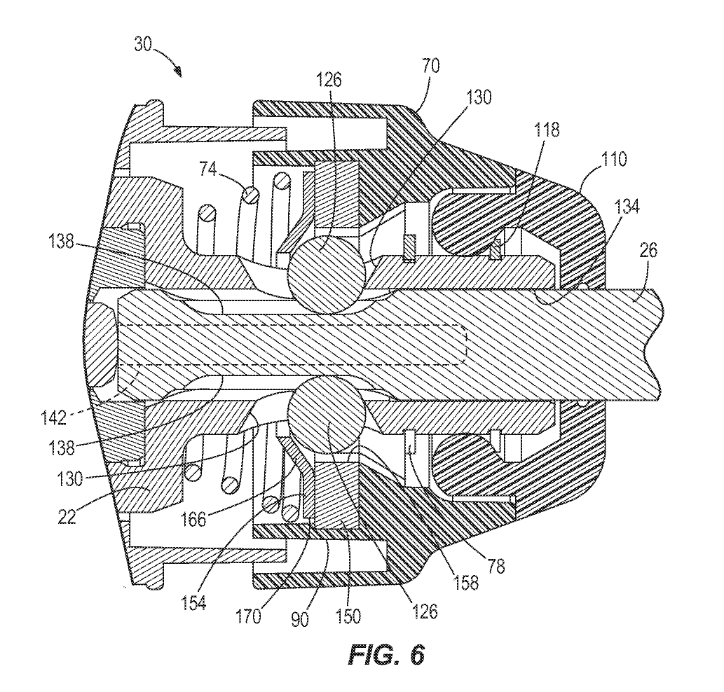

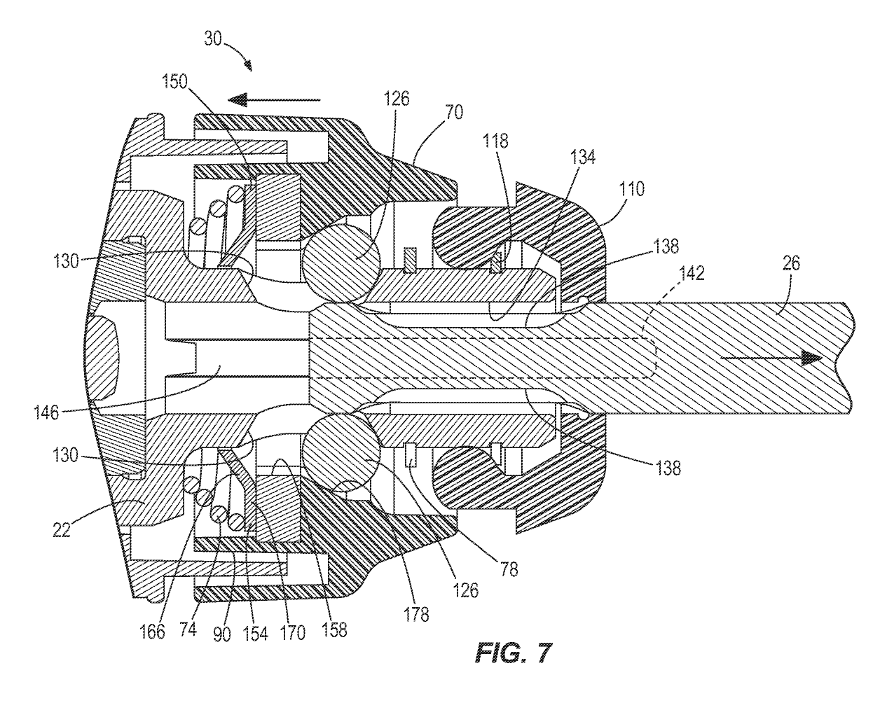

With reference to FIGS. 2, 3, and 5-7, the bit retention assembly 30 includes a collar 70 that is axially displaceable along the spindle 22 of the rotary hammer 10 between a first or forward position (FIGS. 5 and 6) and a second or rearward position (FIG. 7), against the bias a coil spring 74. The collar 70 is prevented from moving beyond the forward position by a first retaining ring 78, such as a split ring or C-ring, received within a first retaining groove 82 of the spindle 22 (FIG. 3). The collar 70 is prevented from moving beyond the rearward position by an annular projection 86 (FIG. 2) extending from the housing 14 of the rotary hammer 10.

Best illustrated in FIG. 3, the collar 70 includes an annular wall 90 at least partially defining a pocket 94 for receiving a first end 98 of the spring 74. The pocket 94 and spring 74 are sized such that the first end 98 of the spring 74 is radially constrained by the annular wall 90, thus stabilizing the first end 98 of the spring 74. A second or opposite end 102 of the spring 74 is engaged with a shoulder 106 on the spindle 22.

The rotary hammer 10 further includes a cap 110 located at a front end of the spindle 22. The cap 110 has a hole 114 through which the tool bit 26 extends when the tool bit 26 is fully inserted within the spindle 22. In the illustrated embodiment, the cap 110 is made of rubber. Alternatively, the cap 110 may be made of any other suitable material. The cap 110 is secured to the spindle 22 by a second retaining ring 118, such as a split ring or C-ring, received within a second retaining groove 122 of the spindle 22. Because the collar 70 is retained on the spindle by the first retaining ring 78, the bit retention assembly 30 is still functional if the cap 110 is removed.

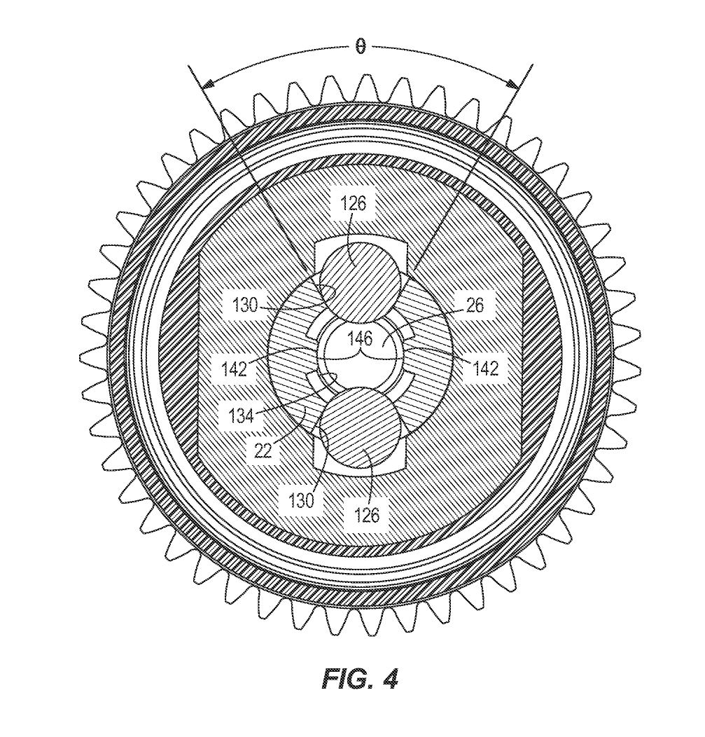

With reference to FIGS. 4 and 6, the bit retention assembly 30 further includes a pair of opposed detent members or balls 126 that are maintained within respective slots 130 formed in the spindle 22. The slots 130 extend between an exterior of the spindle 22 and a receptacle 134 in which the tool bit 26 is inserted. When the tool bit 26 is properly or fully inserted into the receptacle 134, the balls 126 are at least partially received in corresponding indentations 138 formed in a rear portion of the tool bit 26 (i.e., a locking position; FIG. 6) to define the extent to which the tool bit 26 may reciprocate within the spindle 22. The tool bit 26 also includes a pair of opposed, axially-extending keyways 142 that slidably receive corresponding keys 146 located in the receptacle 134 of the spindle (FIG. 4). The engagement between the keys 146 and the keyways 142 provides the primary torque transfer means between the tool bit 26 and the spindle 22. In the illustrated embodiment, the keys 146 and keyways 142 are offset from the balls 126, slots 130, and indentations 138 by an angle of about 90 degrees. The spindle 22 is made of a case-hardened steel to increase the durability of the spindle 22 and particularly of the keys 146. In some embodiments, the steel may be hardened using a carbonitriding heat treatment process, in which atoms of carbon and nitrogen are diffused into the steel. In other embodiments, the steel may be hardened using any other suitable process, such as a boronizing process. Alternatively, the spindle 22 may be made of any other suitably hard and durable material.

With continued reference to FIG. 4, the slots 130 in the spindle 22 define an included slot angle θ between about 30 degrees and about 90 degrees. In the illustrated embodiment, the slot angle θ is about 60 degrees. This relatively steep angle θ allows the engagement between the balls 126 and the indentations 138 in the tool bit 26 to provide a secondary torque transfer means between the tool bit 26 and the spindle 22. As such, if the keys 146 and/or keyways 142 begin to wear, torque may still be reliably transmitted to the tool bit 26.

Referring to FIGS. 5-7, the bit retention assembly 30 further includes a ring 150 fixed within the pocket 94 of the collar 70 and a washer 154 positioned between the spring 74 and the collar 70. In the illustrated embodiment, the ring 150 is insert molded with the collar 70; however, the ring 150 may be fixed to the collar 70 by any other suitable method. The ring 150 is positioned radially outward of the balls 126 when in the position of FIG. 6, such that an inner surface 158 of the ring 150 prevents the balls 126 from being displaced out of the indentations 138 when the tool bit 26 is fully inserted within the spindle 22.

Best illustrated in FIG. 3, the washer 154 includes a circular aperture 162 through which the spindle 22 extends, a tapered inner portion 166 adjacent the aperture 162, and a substantially flat outer periphery 170. In the illustrated embodiment, the inner portion 166 has a frustoconical shape that is substantially uniform in a circumferential direction. The spring 74 bears against the outer periphery 170 of the washer 154, and the inner portion 166 of the washer engages the balls 126 to bias the balls 126 forward in the slots 130.

To secure the tool bit 26 within the bit retention assembly 30, the tool bit 26 is inserted within the spindle 22, causing the rear portion of the tool bit 26 to engage the balls 126 to push them rearward against the washer 154 and the bias of the spring 74. Because the inner portion 166 of the washer 154 is substantially uniform in the circumferential direction, the balls 126 move rearward in unison. When the balls 126 clear the ring 150, the balls 126 are also displaced radially outward toward a gap 174 created between the washer 154 and the ring 150 (i.e., in an insertion position), until the balls 126 clear the end of the tool bit 26. The balls 126 and washer 154 are returned to the position shown in FIG. 6 by the spring 74 in response to the balls 126 clearing the end of the tool bit 26, at which time the balls 126 are at least partially received in the indentations 138 of the tool bit 26 (i.e., the locking position) to define the extent to which the tool bit 26 may reciprocate within the spindle 22.

To release the tool bit 26 from the bit retention assembly 30, the collar 70 is pushed to the rearward position against the bias of the spring 74, thereby moving with it the washer 154 and the ring 150 (FIG. 7). The balls 126 become aligned with an annular recess 178 in the collar 70 adjacent the ring 150, allowing the balls 126 to be displaced radially outward and into the annular recess 178 (i.e., in a release position) in response to a removal force applied to the tool bit 26.

Various features of the invention are set forth in the following claims.

What is claimed is:

1. A rotary hammer adapted to impart axial impacts to a tool bit, the rotary hammer comprising:
a motor;
a spindle coupled to the motor for receiving torque from the motor;
a piston at least partially received within the spindle for reciprocation therein;
an anvil received within the spindle for reciprocation in response to reciprocation of the piston, the anvil imparting axial impacts to the tool bit in response to reciprocation of the piston; and
a bit retention assembly for securing the tool bit to the spindle, the bit retention assembly including
a plurality of detent members movable in unison from a locking position to an insertion position in response to insertion of the tool bit within the spindle,
a biasing member configured to bias the detent members toward the locking position, and
a collar movable along the spindle between a first axial position and a second axial position, the collar having an annular wall at least partially defining a pocket,
wherein a first end of the biasing member is received within the pocket when the detent members are in the locking position such that the first end of the biasing member is radially constrained by the annular wall.

2. The rotary hammer of claim 1, wherein the spindle includes a receptacle in which the tool bit is received, and
a plurality of slots extending between an exterior of the spindle and the receptacle, each of the slots receiving a corresponding one of the plurality of detent members therein.

3. The rotary hammer of claim 2, wherein each of the slots has an included slot angle between about 30 degrees and about 90 degrees.

4. The rotary hammer of claim 3, wherein each of the slots has an included slot angle of about 60 degrees.

5. The rotary hammer of claim 2, wherein the spindle further includes a pair of keys projecting inwardly into the receptacle, and wherein the tool bit includes a pair of axially-extending keyways that slidably receive the keys when the tool bit is inserted within the spindle.

6. The rotary hammer of claim 5, wherein the tool bit further includes a plurality of indentations, each of the indentations receiving a corresponding one of the plurality of detent members therein when the tool bit is inserted within the spindle and when the detent members are in the locking position.

7. The rotary hammer of claim 6, wherein torque is transferred from the spindle to the tool bit through the keys and through the detent members.

8. The rotary hammer of claim 1, wherein the plurality of detent members comprises two opposed balls.

9. The rotary hammer of claim 1, wherein the bit retention assembly further includes
a ring fixed within the pocket, and
a washer disposed between the first end of the biasing member and the plurality of detent members,
wherein the washer includes a tapered inner portion that engages the detent members to bias the detent members toward the locking position.

10. The rotary hammer of claim 9, wherein the washer includes a generally flat outer periphery, wherein the outer periphery of the washer contacts the ring when the detent members are in the locking position, and wherein the outer periphery of the washer is spaced from the ring to form a gap in which at least a portion of the detent members are received when the detent members are in the insertion position.

11. The rotary hammer of claim 9, wherein the washer further includes a circular aperture through which the spindle extends.

12. The rotary hammer of claim 9, wherein an inner surface of the ring radially constrains the detent members when the detent members are in the locking position and the collar is in the first axial position.

13. The rotary hammer of claim 1, further comprising a first retaining ring coupled to the spindle and engageable with the collar to prevent axial movement of the collar past the first axial position.

14. The rotary hammer of claim 13, further comprising
a cap located at a front end of the spindle, the cap including a hole through which the tool bit extends when the tool bit is inserted within the spindle, and
a second retaining ring coupled to the spindle for retaining the cap on the spindle.

15. The rotary hammer of claim 1, wherein the detent members are movable from the locking position to a release position in response to a removal force being applied to the tool bit when the collar is in the second axial position.

16. The rotary hammer of claim 1, wherein the spindle is made of material hardened by a carbonitriding process.

17. The rotary hammer of claim 1, further comprising a striker received within the spindle for reciprocation in response to reciprocation of the piston, wherein the anvil is positioned between the striker and the tool bit.

18. The rotary hammer of claim 1, wherein the biasing member is a coil spring.

19. The rotary hammer of claim 1, wherein the spindle includes a shoulder, and wherein a second end of the biasing member bears against the shoulder.

20. A bit retention assembly for securing a tool bit to a spindle of a rotary hammer, the bit retention assembly comprising:
a plurality of detent members movable in unison from a locking position to an insertion position in response to insertion of the tool bit within the spindle;
a biasing member configured to bias the detent members toward the locking position; and
a collar movable along the spindle between a first axial position and a second axial position, the collar having an annular wall at least partially defining a pocket,
wherein a first end of the spring is received within the pocket when the detent members are in the locking position such that the first end of the spring is radially constrained by the annular wall.
